(19) United States
(12) Patent Application Publication
(10) Pub. No.: US 2019/0033893 A1
(43) Pub. Date: Jan. 31, 2019

(54) UAV autonomous swarm formation rotation control method based on simulated migratory bird evolutionary snowdrift game

(71) Applicant: BEIHANG UNIVERSITY, Beijing (CN)

(72) Inventors: Haibin Duan, Beijing (CN); Huaxin Qiu, Beijing (CN); Yimin Deng, Beijing (CN); Chen Wei, Beijing (CN); Mengzhen Huo, Beijing (CN); Pei Li, Beijing (CN); Daifeng Zhang, Beijing (CN); Qing Yang, Beijing (CN); Yankai Shen, Beijing (CN); Xiaobin Xu, Beijing (CN); Long Xin, Beijing (CN); Rui Zhou, Beijing (CN)

(73) Assignee: BEIHANG UNIVERSITY

(21) Appl. No.: 16/147,496

(22) Filed: Sep. 28, 2018

(30) Foreign Application Priority Data
Jan. 11, 2018 (CN) 201810026713.3

(51) Int. Cl. G05D 1/10; G05D 1/00; B64C 39/02

(52) U.S. Cl. CPC G05D 1/104; B64C 2201/141; B64C 39/024; G05D 1/0088

(57) ABSTRACT

A UAV autonomous swarm formation rotation control method based on a simulated migratory bird evolutionary snowdrift game includes steps of: Step 1: initializing; Step 2: determining flight mode based on a migratory bird evolutionary snowdrift game; Step 3: determining the leader and its position relative to corresponding wing UAV; Step 4: running UAV model; and Step 5: determining whether to end simulation. The present invention is to provide a distributed UAV autonomous swarm formation rotation control method, so as to improve robustness and adaptability of the UAV in autonomous swarm formation rotation, thus effectively improving long-range mission execution capability of the UAV.

### CROSS REFERENCE OF RELATED APPLICATION

The present invention claims priority under 35 U.S.C. 119(a-d) to CN 201810026713.3, filed Jan. 11, 2018.

### BACKGROUND OF THE PRESENT INVENTION

### Field of Invention

The present invention relates to a UAV autonomous swarm formation rotation control method based on a simulated migratory bird evolutionary snowdrift game, belonging to a technical field of UAV control.

### Description of Related Arts

Unmanned Aerial Vehicle (UAV) is a powered aircraft that does not carry an operator, uses aerodynamics to provide lift, can fly autonomously or remotely, can be used once and can be recycled, and carries deadly or non-fatal payloads. It has the basic attributes of “unmanned platform and manned system,” and has broad application prospects in military and civilian fields.

The increased onboard capacity of the UAV has changed the mission execution mode thereof. In the conventional mission execution mode, UAVs typically perform long-range missions by refueling in the air. In the changed mission execution mode, the UAVs will perform long-distance tasks in the form of swarms, which are delivered and recycled by the host. Since the host cannot reach the mission area under normal circumstances for avoiding loss, the UAV swarm needs to have strong endurance. The formation of the UAV swarm enables the wing UAV in the swarm to effectively utilize the wake of the leader to reduce drag, save fuel, and extend range. However, the leading UAV of the swarm cannot use the wake of any UAV, so its range is not extended. Therefore, the UAV swarm formation does not extend the overall range of the UAV swarm. Only through UAV swarm formation rotation, which means the UAVs of the swarm take turns to act as the leading UAV, can the overall range of the UAV swarm be effectively extended. That is to say, the design of a reasonable and effective UAV autonomous swarm formation rotation control method is vital. The present invention aims to improve the formation control level of the UAV autonomous swarm by designing a UAV autonomous swarm formation rotation control method, so that the UAVs can perform the long-distance task with a lower fuel configuration.

Conventionally, the common method of UAV swarm rotation is mainly cyclical method, namely when a certain UAV in the swarm consumes the prescribed fuel as a leading UAV, UAVs in the swarm moves in a clockwise or counterclockwise direction to act as a leading UAV the swarm in turn. Although this method is simple and easy, it has drawbacks as follows. Firstly, when a UAV in the UAV swarm fails, the method cannot continue to execute, so the robustness is poor. Secondly, the method is not applicable to unconventional swarm formation except V formation and echelon formation. Besides, when the UAV fuel distribution in the UAV swarm is uneven, the method is not reasonable and the adaptability is insufficient. Aiming at the lack of autonomous abilities of the conventional UAV swarm formation rotation method in terms of robustness and adaptability, the present invention simulates migratory behavior of migratory birds, and designs a distributed UAV autonomous swarm formation rotation control method based on an evolutionary snowdrift game.

In order to save energy and increase chances of survival, migratory birds usually migrate in a tight linear formation, and there are positional rotation cooperative behaviors. Regardless of their internal kinship, the migratory birds in the swarm have roughly the same leading and following time, which means all individuals have the opportunity to fly in the wakes of other individuals, and are willing to sacrifice their own interests to become the general leader. This rotation of migratory birds is consistent with the payoff structure of the snowdrift game. When two individuals meet, each individual has two choices: leading (cooperation) or following (defection). If both choose to cooperate, they will both get the benefits, but at the same time bear the cost. If both choose to defect, the gain is zero. If one individual cooperates and the other defects, the defector gains more payoff than the cooperator. There is a similarity in the payoff structure between the UAV swarm formation rotation problem and the migratory bird general leader rotation problem. In addition, the UAV has limited intelligence and the environment is complex, so the individual cannot immediately obtain the current best strategy, which is in line with consideration of the limitations of individual intelligence in the evolutionary game. Individuals in the evolutionary game follow the simple rules to update the strategy and finally reach the evolutionarily stable strategy. In summary, the present invention proposes a UAV autonomous swarm formation rotation control method based on a simulated migratory bird evolutionary snowdrift game to overcome the deficiency of robustness and adaptability of the conventional UAV swarm formation rotation control method, which effectively improves the formation control level of the UAV autonomous swarm.

### SUMMARY OF THE PRESENT INVENTION

The present invention provides a UAV autonomous swarm formation rotation control method based on a simulated migratory bird evolutionary snowdrift game. An object of the present invention is to provide a distributed UAV autonomous swarm formation rotation control method, so as to improve robustness and adaptability of the UAV in autonomous swarm formation rotation, thus effectively improving long-range mission execution capability of the UAV.

Accordingly, in order to accomplish the above objects, the present invention provides a UAV autonomous swarm formation rotation control method based on a simulated migratory bird evolutionary snowdrift game as shown in FIG. 1, comprising steps of:

Step 1: initializing:

randomly generating initial states of N UAVs, comprising a position Pⁱ, a horizontal speed Vⁱ, and a heading angle ψⁱ, wherein i is a UAV index, Pⁱ=(Xⁱ, Yⁱ), Xⁱ and Yⁱ are respectively the horizontal coordinate and the vertical coordinate of the UAV i in the ground coordinate system; setting the index of the leader of each UAV to N_{lead}ⁱ=0, setting current simulation time to t=0, setting a simulation counter to n=1, setting a rotation counter to Count=1, and setting a game counter to nᵢ=0; wherein only when no UAV j satisfies X^{j}≥Xⁱ and Y^{j}≥Yᵢ, the flight mode identifier Flag_{lead}ⁱ(n) of UAV i is 1, the strategy S″(n) of UAV i is 1, and the reverse strategy Sᵣ^{j}(n) of UAV i is 0; otherwise, the flight mode identifier Flag_{lead}ⁱ(n) is 0, the strategy Sⁱ(n) is 0, and the reverse strategy Sᵣⁱ(n) is 1;

Step 2: determining flight mode based on a migratory bird evolutionary snowdrift game:

wherein if the simulation counter n>1 and the Count is less than a maximum limit Countₘₐₓ of the rotation counter, then the rotation counter is increased by one, and the strategy, the reverse strategy and the flight mode identifier remain unchanged, which are Count=Count+1, Sⁱ(n)=Sⁱ(n−1), Sᵣⁱ(n)=Sᵣⁱ(n−1), Flag_{lead}ⁱ(n)=Flag_{lead}ⁱ(n−1), and a Step 3 is executed;

wherein if Count=Countₘₐₓ, then the rotation counter is set to one, the neighbor strategy set Sₙ of UAV i is cleared, and the game counter is increased by one, which are Count=1, Sₙⁱ=Ø, n₁=nₙ+1; only when no UAV j satisfies X^{j}≥Xⁱ and Y^{j}≥Yⁱ, the strategy S^{d}(n) is 0, the reverse strategy Sᵣⁱ(n) is 1, the memory strategy Sₘ^{d}(n₁) of UAV i is 0, and the flight mode identifier Flag_{lead}ⁱ(n) is 0, then a Step 4 is executed; otherwise, a swarm consisting of the N UAVs is treated as a migratory bird flock, wherein a UAV i is a migratory bird i, the leader N_{lead}^{j} of the UAV i is the leader N_{lead}^{j} of the migratory bird i, the strategy Sⁱ (n) and the reverse strategy Sᵣⁱ (n) of the UAV i are respectively the strategy Sⁱ(n) and the reverse strategy Sᵣⁱ(n) of the migratory bird i in an evolutionary snowdrift game;

wherein if there is a migratory bird j satisfies N_{lead}^{j}=i, the strategy of the migratory bird j is stored in a neighbor strategy set of the migratory bird i, which is S^{j} (n) ∈Sₙⁱ, if the migratory bird i has a leader, which is N_{lead}ⁱ≠0, the strategy of the migratory bird N_{lead}ⁱ is stored in the neighbor strategy set of the migratory bird i, which is S^{Ni}^{_{lead}} (n) ∈Sₙⁱ, real snowdrift game payoff Bⁱ of the migratory bird i is calculated according to the strategy Sⁱ (n) and the neighbor strategy Sₙⁱ of the migrato bird i:

$${B}^{i} = \{ \begin{matrix}1 + {r}_{1} , if {S}^{i} ( n ) = 0 , 1 ∈ {S}_{n}^{i} \\ 1 , if {S}^{i} ( n ) = 1 , 1 ∉ {S}_{n}^{i} \\ 1 - {r}_{2} , if {S}^{i} ( n ) = 1 , 1 ∈ {S}_{n}^{i} \\ 0 , if {S}^{i} ( n ) = 0 , 1 ∉ {S}_{n}^{i}\end{matrix} \qquad ( 1 )$$

wherein r₁ is a benefit coefficient of a non-cooperator encountering cooperators, r₂ is a cost coefficient of a cooperator encountering cooperators; virtual snowdrift game payoff Bᵣⁱ of the migratory bird i is calculated according to the reverse strategy Sᵣⁱ(n) and the neighbor strategy Sₙⁱ of the migratory bird i:

$${B}_{r}^{i} = \{ \begin{matrix}1 + {r}_{1} , if {S}_{r}^{i} ( n ) = 0 , 1 ∈ {S}_{n}^{i} \\ 1 , if {S}_{r}^{i} ( n ) = 1 , 1 ∉ {S}_{n}^{i} \\ 1 - {r}_{2} , if {S}_{r}^{i} ( n ) = 1 , 1 ∈ {S}_{n}^{i} \\ 0 , if {S}_{r}^{i} ( n ) = 0 , 1 ∉ {S}_{n}^{i}\end{matrix} \qquad ( 2 )$$

calculating the memory strategy Sₘⁱ(n₁) of the migratory bird i according to the real snowdrift game payoff Bⁱ and the virtual snowdrift game payoff Bᵣⁱ of the migratory bird i:

$${S}_{m}^{i} ( {n}_{1} ) = \{ \begin{matrix}{S}^{i} ( n ) , if {B}_{r}^{i} \leq {B}^{i} \\ {S}_{r}^{i} ( n ) , if {B}_{r}^{i} > {B}^{i}\end{matrix} \qquad ( 3 )$$

generating a selection probability p_{g} of snowdrift game strategies based on the memory strategy Sₘⁱ of the migratory bird i:

$${p}_{g} = \{ \begin{matrix}\frac{{\sum }_{k = 1}^{{n}_{1}} {S}_{m}^{i} ( k )}{{n}_{1}} , if {n}_{1} < {L}_{m} \\ \frac{{\sum }_{k = {n}_{1} - {L}_{m} + 1}^{{n}_{1}} {S}_{m}^{i} ( k )}{{L}_{m}} , if {n}_{1} \geq {L}_{m}\end{matrix} \qquad ( 4 )$$

wherein Lₘ is the memory length of the snowdrift game; a random number rand is randomly generated, and the strategy Sⁱ(n) and the reverse strategy Sᵣⁱ(n) of the migratory bird i are generated according to the selection probability p_{g} of the snowdrift game strategies of the migratory bird i:

$$\begin{matrix}{S}^{i} ( n ) = \{ \begin{matrix}1 , & if rand < {p}_{g} \\ 0 , & if rand \geq {p}_{g}\end{matrix} & ( 5 ) \\ {S}_{r}^{i} ( n ) = \{ \begin{matrix}0 , & if rand < {p}_{g} \\ 1 , & if rand \geq {p}_{g}\end{matrix} & ( 6 )\end{matrix}$$

updating the flight mode identifier Flag_{lead}ⁱ(n) of the UAV i based on the strategy Sⁱ(n) of the migratory bird i:

$${Flag}_{lead}^{i} ( n ) = \{ \begin{matrix}1 , if {S}^{i} ( n ) = 1 \\ 0 , if {S}^{i} ( n ) = 0\end{matrix} \qquad ( 7 )$$

Step 3: determining the leader and its position relative to corresponding wing UAV:

wherein if the flight mode identifier Flag_{lead}ⁱ(n) is 0, the UAV i is in a wing UAV mode, which selects a nearest front UAV as the leader; if there are more than one options, the UAV i selects a UAV with a smallest index as the leader; which means only when X^{j}>Xⁱ and there is no UAV j′ satisfies X^{j}′>Xⁱ and a R^{ij}′<R^{ij}, or satisfies X^{j}′>Xⁱ, R^{ij}′=R^{ij} and j′<j, there is N_{lead}ⁱ=j, wherein R^{ij}=\sqrt{(Xⁱ−X^{j})²+(Yⁱ−Y^{j})²} is the distance between the UAV i and the UAV j; if there is no front UAV, the UAV i in the wing UAV mode selects a nearest UAV as the leader; if there are more than one options, the UAV i selects the UAV with the smallest index as the leader; which means only when there is no UAV j′ satisfies X^{j}′>Xⁱ and there is no UAVj″ satisfies R^{ij}″<R^{ij}, or satisfies R^{ij}″=R^{ij} and j″<j, there is N_{lead}ⁱ=j, according to current positions of the UAV i and the corresponding leader N_{lead}ⁱ, an expected forward position x̅ⁱ and an expected lateral position y̅ⁱ of the corresponding leader N_{lead}ⁱ relative to the UAV i are calculated:

$$\begin{matrix}{\overline{x}}^{i} = {x}_{exp} & ( 8 ) \\ {\overline{y}}^{i} = \{ \begin{matrix}{y}_{exp} , if {Y}^{i} \geq {Y}^{{N}_{lead}^{i}} \\ - {y}_{exp} , if {Y}^{i} < {Y}^{{N}_{lead}^{i}}\end{matrix} & ( 9 )\end{matrix}$$

wherein xₑₓₚ and yₑₓₚ are respectively the expected forward distance and the expected lateral distance, Y^{Ni}^{_{lead}} is the vertical coordinate of the leader of the UAV i in the ground coordinate system;

Step 4: finning UAV model:

wherein if the flight mode identifier Flag_{lead}ⁱ(n) is 1, the UAV i is in a leading UAV mode; the UAV state at next simulation time is obtained according to a leading UAV model:

$$\{ \begin{matrix}{\dot{X}}^{i} = {V}^{i} cos {ψ}^{i} \\ {\dot{Y}}^{i} = {V}^{i} sin {ψ}^{i} \\ {\dot{V}}^{i} = - \frac{1}{{τ}_{V}} {V}^{i} + \frac{1}{{τ}_{V}} {V}_{{L}_{C}} \\ {\dot{ψ}}^{i} = - \frac{1}{{τ}_{ψ}} {ψ}^{i} + \frac{1}{{τ}_{ψ}} {ψ}_{{L}_{C}} \end{matrix} \qquad ( 10 )$$

wherein \dot{X}ⁱ, \dot{Y}ⁱ, \dot{V}ⁱ and \dot{ψ}ⁱ are respectively first-order differentials of the horizontal coordinate, the vertical coordinate, the speed, and the heading angle of the UAV i in the ground coordinate system; τ_{V} and τ_{ψ} are respectively time constants of a Mach-hold autopilot and a heading-hold autopilot; the Mach-hold autopilot control input V_{L}_{_{c}} of the leading UAV is Vₑₓₚ, and the heading-hold autopilot control input ψ_{L}_{_{c}} of the leading UAV is ψₑₓₚ, Vₑₓₚ and ψₑₓₚ are respectively the expected horizontal speed and the expected heading angle of the leading UAV; if the flight mode identifier Flag_{lead}ⁱ(n) is 0, the UAV state at next simulation time is Obtained according to a wing UAV model:

$$\{ \begin{matrix}[ \begin{matrix}{X}^{i} \\ {Y}^{i}\end{matrix} ] = [ \begin{matrix}{X}^{{N}_{lead}^{i}} \\ {Y}^{{N}_{lead}^{i}}\end{matrix} ] - [ \begin{matrix}cos {ψ}^{i} & sin {ψ}^{i} \\ sin {ψ}^{i} & - cos {ψ}^{i}\end{matrix} ] [ \begin{matrix}{x}^{i} \\ {y}^{i}\end{matrix} ] \\ {\dot{x}}^{i} = - \frac{{\overline{y}}^{i}}{{τ}_{ψ}} {ψ}^{i} - {V}^{i} + {V}^{{N}_{lead}^{i}} + \frac{{\overline{y}}^{i}}{{τ}_{ψ}} {ψ}_{{W}_{C}} \\ {\dot{y}}^{i} = ( \frac{{\overline{x}}^{i}}{{τ}_{ψ}} - {V}^{i} ) {ψ}^{i} + {V}^{i} {ψ}^{i} - \frac{{\overline{x}}^{i}}{{τ}_{ψ}} {ψ}_{{W}_{C}} \\ {\dot{V}}^{i} = - \frac{1}{{τ}_{V}} {V}^{i} + \frac{1}{{τ}_{V}} {V}_{{W}_{C}} \\ {\dot{ψ}}^{i} = - \frac{1}{{τ}_{ψ}} {ψ}^{i} + \frac{1}{{τ}_{ψ}} {ψ}_{{W}_{C}} \end{matrix} \qquad ( 11 )$$

wherein X^{Ni}^{_{lead}} and V^{Ni}^{_{lead}} are respectively the horizontal coordinate and the speed of the leader of the UAV i in the ground coordinate system, xⁱ and yⁱ are respectively the horizontal coordinate and the vertical coordinate of the UAV N_{lead}ⁱ in the aircraft-body coordinate system of the UAV i; the Mach-hold autopilot control input of the wing UAV is

$${V}_{Wc} = {k}_{{x}_{p}} {e}_{x} + {k}_{{x}_{I}} {\int }_{0}^{t} {e}_{x} dt + {k}_{{x}_{D}} \frac{{de}_{x}}{dt} ,$$

and the heading-hold autopilot control input of the wing UAV is

$${ψ}_{Wc} = {k}_{{y}_{p}} {e}_{y} + {k}_{{y}_{I}} {\int }_{0}^{t} {e}_{y} dt + {k}_{{y}_{D}} \frac{{de}_{y}}{dt} ,$$

(kₓ_{ₚ}, kₓ_{_{I}}, kₓ_{_{D}}) and (k_{y}_{ₚ}, k_{y}_{_{I}}, k_{y}_{_{D}}) are respectively PID (Proportional Integral Derivative) control parameters of a forward channel and a lateral channel, eₓ=(x̅ⁱ−xⁱ)+k_{V}(V^{Ni}^{_{lead}}−Vⁱ) is an error of the forward channel, e_{y}=k_{y}(y̅ⁱ−yⁱ)+k₁₀₄ (ψ^{Ni}^{_{lead}}−ψⁱ) is an error of the lateral channel, kₓ, k_{V}, k_{y} and k_{ψ} are respectively a forward error control gain, a speed error control gain, a lateral error control gain and a heading error control gain, ψ^{Ni}^{_{lead}} is the heading angle of the leader of the UAV i; and

Step 5: determining whether to end simulation:

wherein the simulation time is t=t+ts, and is is a sampling time; if t is greater than a maximum simulation time Tₘₐₓ, the simulation ends; then a UAV swarm flight trajectory, UAV swarm formations at each rotation time, a UAV swarm horizontal speed curve and a UAV swarm heading angle curve are drawn; otherwise, the simulation returns to the Step 2.

### Advantages and Effects

The present invention provides a UAV autonomous swarm formation rotation control method based on a simulated migratory bird evolutionary snowdrift game. The method is a distributed control method based on the evolutionary snowdrift game, which simulates migration of migratory birds. The main advantages are mainly reflected in two aspects: first, the method simulates local interaction of migratory birds, so as to generate a UAV swarm formation rotation strategy based only on recent history information of the UAVs and neighbors within a small range, which reduces onboard computing and communication load; second, the method inherits environmental adaptability characteristics of the migratory birds during migration, wherein operation process does not depend on UAV swarm formation and overall fuel configuration, which can cope with sudden failures, and has strong adaptability as well as robustness, thus effectively improving UAV autonomous swarm formation capability.

### BRIEF DESCRIPTION OF THE DRAWINGS

FIG. 1 is a flow chart of UAV autonomous swarm formation rotation control based on a simulated migratory bird evolutionary snowdrift game.

FIG. 2 shows a UAV swarm flight trajectory.

FIG. 3 shows a UAV swarm formation at t=3s.

FIG. 4 shows a UAV swarm formation at t=6s.

FIG. 5 shows a UAV swarm formation at t=9s.

FIG. 6 shows a UAV swarm formation at t=12s.

FIG. 7 shows a UAV swarm horizontal speed curve.

FIG. 8 shows UAV swarm heading angle curve.

### ELEMENT REFERENCE

t—simulation time; n—simulation counter Count—rotation counter; i—UAV index; Countₘₐₓ—rotation counter maximum limit; Flag_{lead}ⁱ(n)—flight mode identifier of UAV i when simulation counter is n; N—the number of UAVs; Tₘₐₓ—maximum simulation time; ts—sampling time.

### DETAILED DESCRIPTION OF THE PREFERRED EMBODIMENT

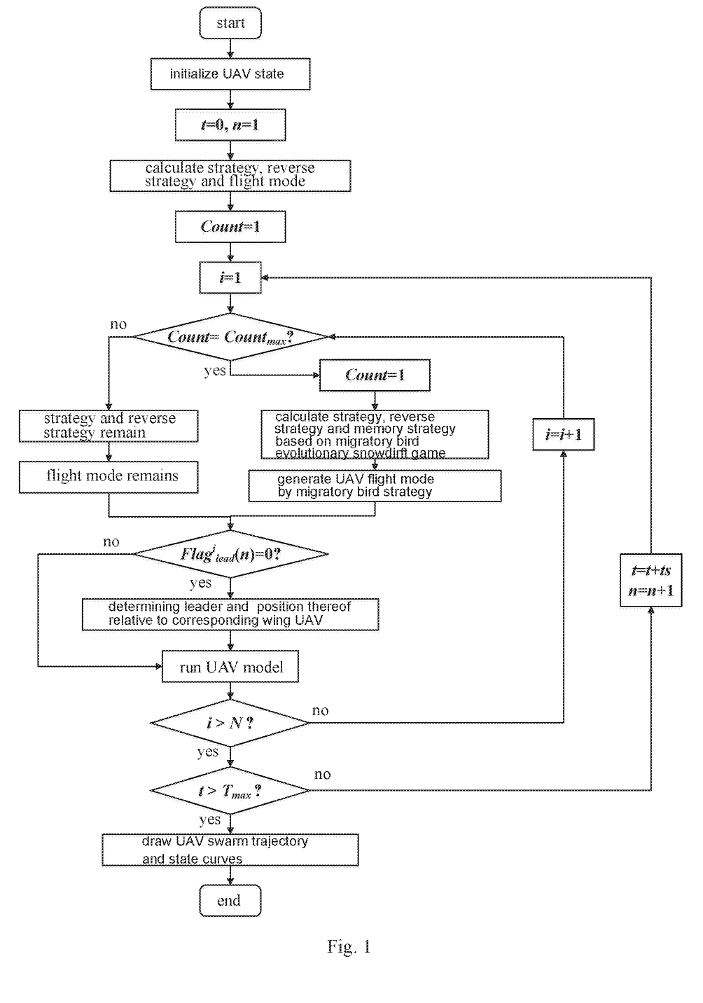

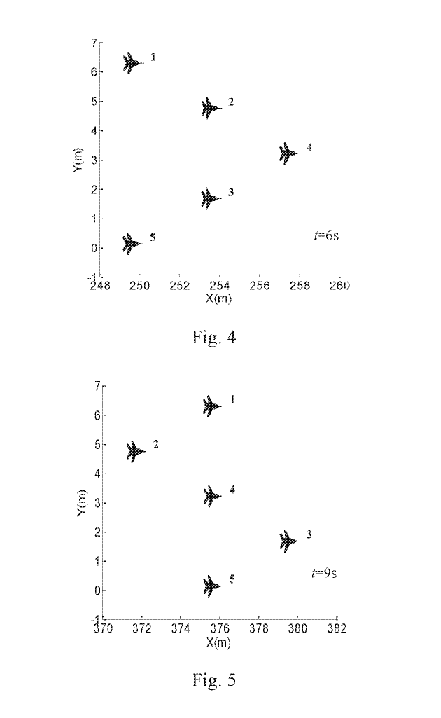

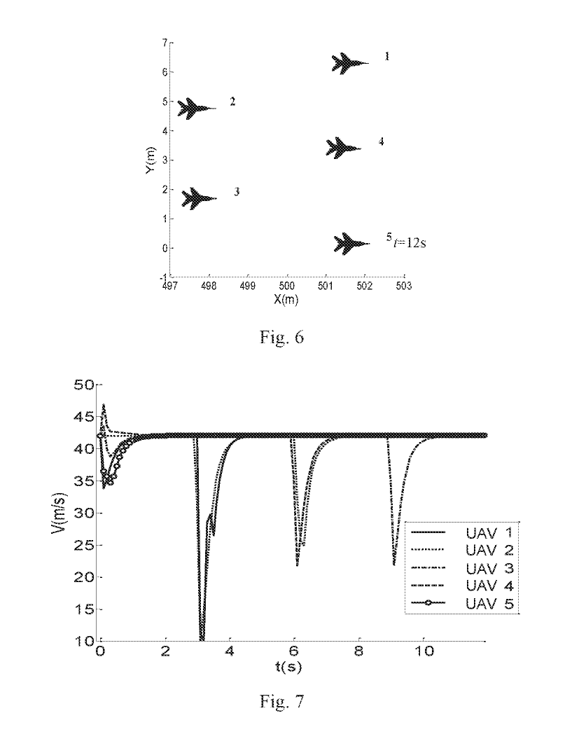

Referring to FIGS. 1-8, effectiveness of the present invention is verified by an embodiment of a UAV autonomous swarm formation rotation control. An experimental computer is configured as Intel Core i7-6700HQ processor with 2.60 Ghz frequency, 16G memory, and MATLAB 2014a version software. The method comprises steps of:

Step 1: initializing:

randomly generating initial states of 5 UAVs, comprising positions P¹ to P⁵ of (12.5926 m, 7.1515 m), (13.1907 m, 3.2101 m), (1.4969 m, −3.1140 m), (3.0873 m, 3.5804 m) and (0.5687 m, −5.9005 m) , a horizontal speed Vⁱ of 42 m/s and a heading angle ψⁱ of 0, wherein i=1,2, . . . , 5; setting the index of the leader of each UAV to N_{lead}ⁱ=0, setting current simulation time to t=0, setting a simulation counter to n=1, setting a rotation counter to Count=1, and setting a game counter to n₁=0, wherein i=1,2, . . . , 5, in the embodiment, only when no UAV j satisfies X^{j}≥X²=13.1907 m and Y^{j}≥Y²=3.2101 m, the flight mode identifier Flag_{lead}²(n) is 1, the strategy S²(n) is 1, and the reverse strategy Sᵣ²(n) is 0; otherwise, the flight mode identifiers Flag_{lead}ⁱ(n) of the UAVs 1 and 3-5 are 0, the strategy Sⁱ(n) is 0, and the reverse strategy Sᵣⁱ(n) is 1, wherein i=1,3,4,5;

Step 2: determining flight mode based on a migratory bird evolutionary to snowdrift game:

wherein if the simulation counter n>1 and the Count is less than a maximum limit Countsₘₐₓ=300 of the rotation counter, then the rotation counter is increased by one, and the strategy, the reverse strategy and the flight mode identifier remain unchanged, which are Count=Count+1, Sⁱ(n)=Sⁱ(n−1), Sᵣⁱ(n)=Sᵣⁱ(n−1), Flag_{lead}ⁱ(n)=Flag_{lead}ⁱ(n−1), and a Step 3 is executed; w/herein i=1,2, . . . , 5; if Count=300, then the rotation counter is set to one, the neighbor strategy set Sₙⁱ of UAV i is cleared, and the game counter is increased by one, which are Count=1, Sₙⁱ=Ø, n₁=n₁+1; only when no UAV j satisfies X^{j}≥Xⁱand Y^{j}≥Yⁱ, the strategy Sⁱ(n) is 0, the reverse strategy Sᵢ^{d}(n) is 1, the memory strategy Sₘⁱ(n₁) of UAV i is 0, and the flight mode identifier Flag_{lead}ⁱ(n) is 0, then a Step 4 is executed; otherwise, a swarm consisting of the N UAVs is treated as a migratory bird flock, wherein a UAV i is a migratory bird i, the leader of the N_{lead}^{j} of the UAV i is the leader N_{lead}^{j} of the migratory bird i, the strategy S^{s}(n) and the reverse strategy Sᵣ^{j}(n) of the UAV i are respectively the strategy S^{d}(n) and the reverse strategy Sᵣⁱ(n) of the migratory bird i in an evolutionary snowdrift game; wherein if there is a migratory bird j satisfies N_{lead}^{j}=i, the strategy of the migratory bird j is stored in a neighbor strategy set of the migratory bird i, which is S^{j}(n) ∈Sₙⁱ, if the migratory bird i has a leader, which is N_{lead}^{j}16 0, the strategy of the migratory bird N_{lead}ⁱ is stored in the neighbor strategy set of the migratory bird i, which is S^{Ni}^{_{lead}} (n) ∈Sₙⁱ, real snowdrift game payoff Bⁱ of the migratory bird i is calculated with an equation (1) according to the strategy Sⁱ(n) and the neighbor strategy Sₙⁱ of the migratory bird i; wherein a benefit rᵢ coefficient of a non-cooperator encountering cooperators is 0.5, a cost coefficient r₂ of a cooperator encountering cooperators is 0.2; virtual snowdrift game payoff Bᵣⁱ of the migratory bird i is calculated with an equation (2) according to the reverse strategy Sᵣⁱ(n) and the neighbor strategy Sₙⁱ of the migratory bird i; the memory strategy Sₘⁱ(n₁) of the migratory bird i is calculated with an equation (3) according to the real snowdrift game payoff Bⁱ and the virtual snowdrift game payoff Bᵣⁱ of the migratory bird i; and a selection probability p_{g} of snowdrift game strategies is calculated with an equation (4) based on the memory strategy Sₘ^{j} of the migratory bird i; wherein Lₘ=2 is the memory length of the snowdrift game; a random number rand is randomly generated, and the strategy Sⁱ(n) and the reverse strategy Sᵣⁱ(n) of the migratory bird i are generated with equations (5) and (6) according to the selection probability p_{g} of the snowdrift game strategies of the migratory bird i; and the flight mode identifier Flag_{lead}ⁱ(n) of the UAV i is updated with an equation (7) based on the strategy Sⁱ (n) of the migratory bird i:

Step 3: determining the leader and its position relative to corresponding wing UAV:

wherein if the flight mode identifier Flag_{lead}ⁱ(n) is 0, the UAV i is in a wing UAV mode, which selects a nearest front UAV as the leader; if there are more than one options, the UAV i selects a UAV with a smallest index as the leader; which means only when X^{j}>Xⁱ and there is no UAV j′ satisfies X^{j}′>Xⁱ and R^{ij}′<R^{ij}, or satisfies X^{j}′>Xⁱ, R^{ij}′=R^{ij} and j′<j, there is N_{lead}ⁱ=j, wherein R^{ij}=\sqrt{(Xⁱ−X^{j})²+(Yⁱ−Y^{j})²} is the distance between the UAV i and the UAV j; if there is no front UAV, the UAV i in the wing UAV mode selects a nearest UAV as the leader; if there are more than one options the UAV i selects the UAV with the smallest index as the leader; which means only when there is no UAV j′ satisfies X^{j}′>Xⁱ and there is no UAV j″ satisfies R^{ij}″<R^{ij}, or satisfies and R^{ij}″=R^{ij} and j″<j, there is N_{lead}ⁱ=j, according to current positions of the UAV i and the corresponding lead N_{lead}ⁱ, an expected forward position x̅ⁱ and an expected lateral position y̅ⁱ of the corresponding leader N_{lead}ⁱ relative to the UAV i are calculated with equations (8) and (9); wherein the forward expected distance xₑₓₚ is 3.92 m and the lateral expected distance yₑₓₚ is 1.54 m;

Step 4: finning UAV model:

wherein if the flight mode identifier Flag_{lead}ⁱ(n) is 1, the UAV i is in a leading UAV mode; the UAV state at a next simulation time is obtained with an equation (10) according to a leading UAV model; wherein τᵣ=10 s and τψ=1.5 s are respectively time constants of a Mach-hold autopilot and a heading-hold autopilot: Vₑₓₚ=42 m/s and ψₑₓₚ=0 are respectively the expected horizontal speed and the expected heading angle of the leading UAV; if the flight mode identifier Flag_{lead}ⁱ(n) is 0, the UAV state at next simulation time is obtained with an equation (11) according to a wing UAV model; wherein (kₓ_{ₚ}, kₓ_{_{I}}, kₓ_{_{D}})=(50,50,0.1) and (k_{y}_{ₚ}, k_{y}_{_{I}}, k_{y}_{_{D}})=(1,0.4,0) are respectively PID control parameters of a forward channel and a lateral channel; kᵢ=−15, k_{V}=5, k_{V}=4.5 and k_{ψ}=50 are respectively a forward error control gain, a speed error control gain, a lateral error control gain and a heading error control gain; and

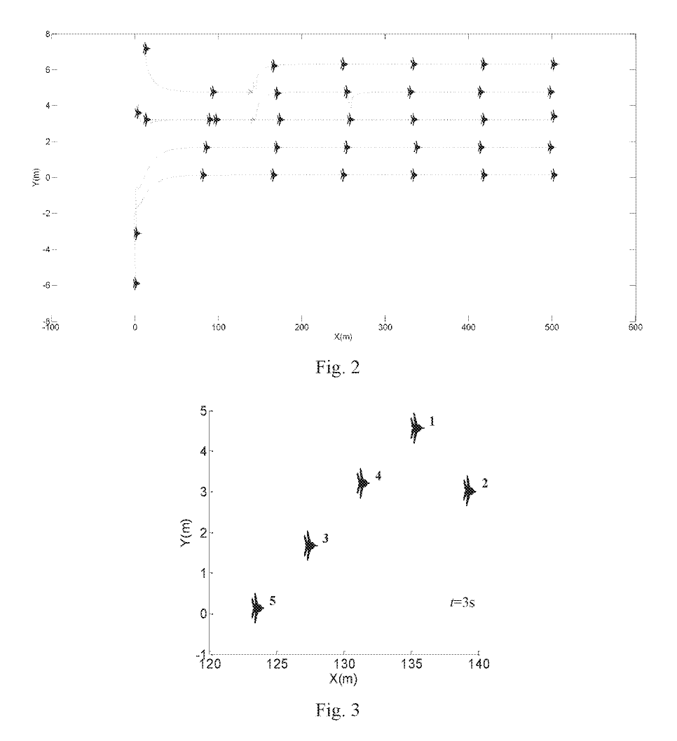

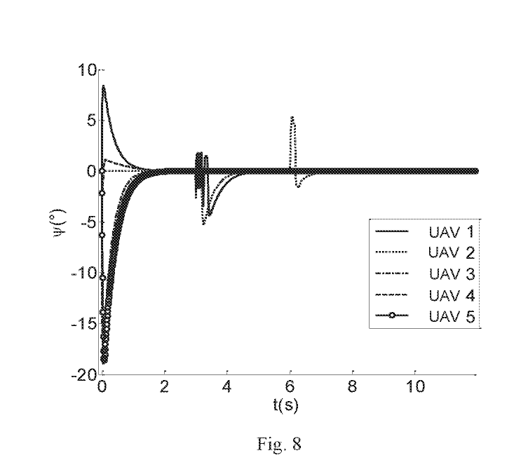

Step 5: determining whether to end simulation:

wherein the simulation time is t=t+ts, and ts=0.01 s is a sampling time; if t is greater than a maximum simulation time Tₘₐₓ=12 s , the simulation ends; then simulation results are drawn; otherwise, the simulation returns to the Step 2. FIG. 2 shows an overall UAV swarm flight trajectory. FIGS. 3-6 show UAV swarm formations at t=3 s, 6 s, 9 s, 12 s. FIGS. 7 and 8 show an overall UAV swarm horizontal speed curve and an overall UAV swarm heading angle curve. According to UAV simulation verification, it is proven that with the UAV autonomous swarm formation rotation control method based on the simulated migratory bird evolutionary snowdrift game of the present invention, the UAV swarm can realize autonomous formation rotation.

What is claimed is:

1. A UAV (Unmanned Aerial Vehicle) autonomous swarm formation rotation control method based on a simulated migratory bird evolutionary snowdrift game, comprising steps of:
Step 1: initializing:
randomly generating initial states of N UAVs, comprising a position Pⁱ, a horizontal speed Vⁱ, and a heading angle ψⁱ, wherein i is a UAV index, Pⁱ=(Xⁱ, Yⁱ), Xⁱ and Yⁱ are respectively a horizontal coordinate and a vertical coordinate of the UAV i in a ground coordinate system; setting an index of a leader of each of the UAVs to N_{lead}ⁱ=0, setting a current simulation time to t=0, setting a simulation counter to n=1, setting a rotation counter to Count=1, and setting a game counter to n₁=0; wherein only when no UAV j satisfies X^{j}≥Xⁱ and Y^{j}≥Yⁱ, a flight mode identifier Flag_{lead}ⁱ(n) of the UAV i is 1, to strategy S^{d}(n) of the UAV i is 1, and a reverse strategy Sᵣ^{d}(n) of the UAV i is 0; otherwise, the flight mode identifier Flag_{lead}ⁱ(n) is 0, the strategy S^{d}(n) is 0, and the reverse strategy Sᵣⁱ(n) is 1;
Step 2: determining a flight mode based on a migratory bird evolutionary snowdrift game:
wherein if the simulation counter n>1 and the Count is less than a maximum limit Countₘₐₓ of the rotation counter, then the rotation counter is increased by one, and the strategy, the reverse strategy and the flight mode identifier remain unchanged, which are Count=Count+1, Sⁱ(n)=Sⁱ(n−1), Sᵣⁱ(n)=Sᵣⁱ(n−1), Flag_{lead}ⁱ(n)=Flag_{lead}ⁱ(n−1), and a Step 3 is executed;
wherein if Count=Countₘₐₓ, then the rotation counter is set to one, a neighbor strategy set Sₙⁱ of the UAV i is cleared, and the game counter is increased by one, which are Count=1, Sₙⁱ=Ø, n₁=n₁+1; only when no UAV j satisfies X^{j}≥Xⁱ and Y^{j}≥Yⁱ, the strategy Sⁱ(n) is 0, the reverse strategy Sᵣⁱ(n) is 1, a memory strategy Sₘⁱ(n₁) of the UAV i is 0, and the flight mode identifier Flag_{lead}ⁱ(n) is 0, then a Step 4 is executed; otherwise, a swarm consisting of the N UAVs is treated as a migratory bird flock, wherein a UAV i is a migratory bird i , a leader N_{lead}^{j} of the UAV i is a leader N_{lead}ⁱ of the migratory bird i , the strategy Sⁱ(n) and the reverse strategy Sᵣⁱ(n) of the UAV i are respectively a strategy Sⁱ(n) and a reverse strategy Sᵣⁱ(n) of the migratory bird i in an evolutionary snowdrift game;
wherein if there is a migratory bird j satisfies N_{lead}^{j}=i, the strategy of a migratory bird j is stored in a neighbor strategy set of the migratory bird i, which is S^{j}(n) ∈Sₙⁱ, if the migratory bird i has a leader, which is N_{lead}ⁱ≠0, the strategy of the migratory bird N_{lead}ⁱ is stored in the neighbor strategy set of the migratory bird i, which is S_{lead}^{N}(n) ∈Sₙⁱ, a real snowdrift game payoff Bⁱ of the migratory bird i is calculated according to the strategy Sⁱ(n) and a neighbor strategy Sₙⁱ of the migratory bird i:
$${B}^{i} = \{ \begin{matrix}1 + {r}_{1} , if {S}^{i} ( n ) = 0 , 1 ∈ {S}_{n}^{i} \\ 1 , if {S}^{i} ( n ) = 1 , 1 ∉ {S}_{n}^{i} \\ 1 - {r}_{2} , if {S}^{i} ( n ) = 1 , 1 ∈ {S}_{n}^{i} \\ 0 , if {S}^{i} ( n ) = 0 , 1 ∉ {S}_{n}^{i}\end{matrix} \qquad ( 1 )$$
wherein r₁ is a benefit coefficient of a non-cooperator encountering cooperators, r₂ is a cost coefficient of a cooperator encountering cooperators; virtual snowdrift game payoff of the migratory bird i is calculated according to the reverse strategy Sᵣⁱ(n) and the neighbor strategy Sₙⁱ of the migratory bird i:
$${B}_{r}^{i} = \{ \begin{matrix}1 + {r}_{1} , if {S}_{r}^{i} ( n ) = 0 , 1 ∈ {S}_{n}^{i} \\ 1 , if {S}_{r}^{i} ( n ) = 1 , 1 ∉ {S}_{n}^{i} \\ 1 - {r}_{2} , if {S}_{r}^{i} ( n ) = 1 , 1 ∈ {S}_{n}^{i} \\ 0 , if {S}_{r}^{i} ( n ) = 0 , 1 ∉ {S}_{n}^{i}\end{matrix} \qquad ( 2 )$$
calculating the memory strategy Sₘⁱ(n₁) of the migratory bird i according to the real snowdrift game payoff Bⁱ and the virtual snowdrift game payoff Bᵣⁱ of the migratory bird i:
$${S}_{m}^{i} ( {n}_{1} ) = \{ \begin{matrix}{S}^{i} ( n ) , if {B}_{r}^{i} \leq {B}^{i} \\ {S}_{r}^{i} ( n ) , if {B}_{r}^{i} > {B}^{i}\end{matrix} \qquad ( 3 )$$
generating a selection probability p_{g} of snowdrift game strategies based on the memory strategy Sₘⁱ, of the migratory bird i:
$${p}_{g} = \{ \begin{matrix}\frac{{\sum }_{k = 1}^{{n}_{1}} {S}_{m}^{i} ( k )}{{n}_{1}} , if {n}_{1} < {L}_{m} \\ \frac{{\sum }_{k = {n}_{1} - {L}_{m} + 1}^{{n}_{1}} {S}_{m}^{i} ( k )}{{L}_{m}} , if {n}_{1} \geq {L}_{m}\end{matrix} \qquad ( 4 )$$
wherein Lₘ is a memory length of the snowdrift game; a random number rand is randomly generated, and the strategy S^{d} (n) and the reverse strategy Sᵣⁱ(n) of the migratory bird i are generated according to the selection probability p_{g} of the snowdrift game strategies of the migratory bird i:
$$\begin{matrix}{S}^{i} ( n ) = \{ \begin{matrix}1 , & if rand < {p}_{g} \\ 0 , & if rand \geq {p}_{g}\end{matrix} & ( 5 ) \\ {S}_{r}^{i} ( n ) = \{ \begin{matrix}0 , & if rand < {p}_{g} \\ 1 , & if rand \geq {p}_{g}\end{matrix} & ( 6 )\end{matrix}$$
updating the flight mode identifier Flag_{lead}ⁱ(n) of the UAV i based on the strategy Sⁱ(n) of the migratory bird i:
$${Flag}_{lead}^{i} ( n ) = \{ \begin{matrix}1 , if {S}^{i} ( n ) = 1 \\ 0 , if {S}^{i} ( n ) = 0\end{matrix} \qquad ( 7 )$$
Step 3: determining the leader and a position thereof relative to a corresponding wing UAV:
wherein if the flight mode identifier Flag_{lead}ⁱ(n) is 0, the UAV i is in a wing UAV mode, which selects a nearest front UAV as the leader; if there are more than one options, the UAV i selects a UAV with a smallest index as the leader; which means only when X^{j}>Xⁱ and there is no UAV j′ satisfies X^{j}′>Xⁱ and R^{ij}′<R^{ij}, or satisfies X^{j}>X^{j}, R^{ij}′=R^{ij} and j′<j, there is N_{lead}ⁱ=j, wherein R^{ij}=\sqrt{(Xⁱ−X^{j})²+(Yⁱ−Y^{j})²} is a distance between the UAV i and the UAV j; if there is no front UAV, the UAV i in the wing UAV mode selects a nearest UAV as the leader; if there are more than one options, the UAV selects the UAV with the smallest index as the leader; which means only when there is no UAV j′ satisfies X^{j}′>X^{j} and there is no UAV j″ satisfies R^{ij}″<R^{ij}, or satisifies R^{ij}″=R^{ij} and j″<j, there is N_{lead}ⁱ=j, according to current positions of the UAV i and a corresponding leader N_{lead}ⁱ, an expected forward position x̅ⁱ and an expected lateral position y̅ⁱ of the corresponding leader N_{lead}ⁱ relative to the UAV i are calculated:
$$\begin{matrix}{\overline{x}}^{i} = {x}_{exp} & ( 8 ) \\ {\overline{y}}^{i} = \{ \begin{matrix}{y}_{exp} , if {Y}^{i} \geq {Y}^{{N}_{lead}^{i}} \\ - {y}_{exp} , if {Y}^{i} < {Y}^{{N}_{lead}^{i}}\end{matrix} & ( 9 )\end{matrix}$$
wherein xₑₓₚ and yₑₓₚ are respectively an expected forward distance and an expected lateral distance, Y^{Ni}^{_{lead}} is a vertical coordinate of the leader of the UAV i in the ground coordinate system;
Step 4: running a UAV model:
wherein if the flight mode identifier Flag_{lead}ⁱ(n) is 1, the UAV i is in a leading UAV mode; a UAV state at a next simulation time is obtained according to the leading UAV model:
$$\{ \begin{matrix}{\dot{X}}^{i} = {V}^{i} cos {ψ}^{i} \\ {\dot{Y}}^{i} = {V}^{i} sin {ψ}^{i} \\ {\dot{V}}^{i} = - \frac{1}{{τ}_{V}} {V}^{i} + \frac{1}{{τ}_{V}} {V}_{{L}_{C}} \\ {\dot{ψ}}^{i} = - \frac{1}{{τ}_{ψ}} {ψ}^{i} + \frac{1}{{τ}_{ψ}} {ψ}_{{L}_{C}} \end{matrix} \qquad ( 10 )$$
wherein \dot{X}ⁱ, \dot{Y}ⁱ, \dot{V}ⁱ and \dot{ψ}ⁱ are respectively first-order differentials of the horizontal coordinate, the vertical coordinate, the speed, and the heading angle of the UAV i in the ground coordinate system; τ_{V} and τ_{ψ} are respectively time constants of a Mach-hold autopilot and a heading-hold autopilot; the Mach-hold autopilot control input V_{L}, of the leading UAV is Vₑₓₚ, and a heading-hold autopilot control input ψ_{L}_{_{c}} of the leading UAV is ψₑₓₚ, Vₑₓₚ and ψₑₓₚ are respectively an expected horizontal speed and an expected heading angle of the leading UAV; if the flight mode identifier Flag_{lead}ⁱ(n) is 0, the UAV state at next simulation time is obtained according to a wing UAV model:
$$\{ \begin{matrix}[ \begin{matrix}{X}^{i} \\ {Y}^{i}\end{matrix} ] = [ \begin{matrix}{X}^{{N}_{lead}^{i}} \\ {Y}^{{N}_{lead}^{i}}\end{matrix} ] - [ \begin{matrix}cos {ψ}^{i} & sin {ψ}^{i} \\ sin {ψ}^{i} & - cos {ψ}^{i}\end{matrix} ] [ \begin{matrix}{x}^{i} \\ {y}^{i}\end{matrix} ] \\ {\dot{x}}^{i} = - \frac{{\overline{y}}^{i}}{{τ}_{ψ}} {ψ}^{i} - {V}^{i} + {V}^{{N}_{lead}^{i}} + \frac{{\overline{y}}^{i}}{{τ}_{ψ}} {ψ}_{{W}_{C}} \\ {\dot{y}}^{i} = ( \frac{{\overline{x}}^{i}}{{τ}_{ψ}} - {V}^{i} ) {ψ}^{i} + {V}^{i} {ψ}^{i} - \frac{{\overline{x}}^{i}}{{τ}_{ψ}} {ψ}_{{W}_{C}} \\ {\dot{V}}^{i} = - \frac{1}{{τ}_{V}} {V}^{i} + \frac{1}{{τ}_{V}} {V}_{{W}_{C}} \\ {\dot{ψ}}^{i} = - \frac{1}{{τ}_{ψ}} {ψ}^{i} + \frac{1}{{τ}_{ψ}} {ψ}_{{W}_{C}} \end{matrix} \qquad ( 11 )$$
wherein X^{Ni}^{_{lead}} and V^{Ni}^{_{lead}} are respectively a horizontal coordinate and a speed of the leader of the UAV i in the ground coordinate system, xⁱ and yⁱ are respectively a horizontal coordinate and a vertical coordinate of the UAV N_{lead}ⁱ in an aircraft-body coordinate system of the UAV i ; the Mach-hold autopilot control input of the wing UAV is
$${V}_{Wc} = {k}_{{x}_{p}} {e}_{x} + {k}_{{x}_{I}} {\int }_{0}^{t} {e}_{x} dt + {k}_{{x}_{D}} \frac{{de}_{x}}{dt} ,$$
and a heading-hold autopilot control input of the wing UAV is
$${ψ}_{Wc} = {k}_{{y}_{p}} {e}_{y} + {k}_{{y}_{I}} {\int }_{0}^{t} {e}_{y} dt + {k}_{{y}_{D}} \frac{{de}_{y}}{dt} ,$$
(kₓ_{ₚ}, kₓ_{_{I}}, kₓ_{_{D}}) and (k_{y}_{ₚ}, k_{y}_{_{I}}, k_{y}_{_{D}}) are respectively PID (Proportional Integral Derivative) control parameters of a forward channel and a lateral channel, eₓ=kₓ(x̅ⁱ−xⁱ)+k_{V}(V^{Ni}^{_{lead}}−Vⁱ) is an error of the forward channel, e_{y}=k_{y}(y̅ⁱ−yⁱ)+k₁₀₄ (ψ^{Ni}^{_{lead}}−ψⁱ) is an error of the lateral channel, kₓ, k_{V}, k_{y} and k_{ψ} are respectively a forward error control gain, a speed error control gain, a lateral error control gain and a heading error control gain, ψ^{Ki}^{_{lead}} is the heading angle of the leader of the UAV i; and
Step 5: determining whether to end simulation:
wherein a simulation time is t=t+ts, and is is a sampling time; if t is greater than a maximum simulation time Tₘₐₓ, the simulation ends; then a UAV swarm flight trajectory, UAV swarm formations at each rotation time, a UAV swarm horizontal speed curve and a UAV swarm heading angle curve are drawn; otherwise, the simulation returns to the Step 2.
